(19) United States
(12) Patent Application Publication
(10) Pub. No.: US 2024/0397174 A1
(43) Pub. Date: Nov. 28, 2024

(54) SURVEILLANCE CAMERA

(71) Applicant: i-PRO CO., LTD., Tokyo (JP)

(72) Inventor: Shinichiro OKAMURA, Tokyo (JP)

(73) Assignee: i-PRO CO., LTD., Tokyo (JP)

(21) Appl. No.: 18/795,809

(22) Filed: Aug. 6, 2024

Related U.S. Application Data
(63) Continuation of application No. PCT/JP2023/001790, filed on Jan. 20, 2023.

(30) Foreign Application Priority Data
Feb. 7, 2022 (JP) 2022-017265

(51) Int. Cl. H04N 23/51; H04N 23/52

(52) U.S. Cl. CPC H04N 23/51; H04N 23/52

(57) ABSTRACT

A surveillance camera includes a housing accommodating at least one heat generation source in an accommodating space; a first housing formed using a metal material, partially constituting the housing, and covering a back surface side of the accommodating space; an intermediate member formed using the metal material and fitted into the first housing to form the accommodating space; a second housing combined with the first housing to constitute the housing; at least one substrate disposed in the accommodating space and on which the at least one heat generation source is mounted, and a first heat transfer unit contacting with the first housing and the at least one heat generation source, and transferring heat of the at least one heat generation source to the first housing.

### CROSS-REFERENCE TO RELATED APPLICATIONS

This is a continuation of International Application No. PCT/JP2023/001790 filed on Jan. 20, 2023, and claims priority from Japanese Patent Application No. 2022-017265 filed on Feb. 7, 2022, the entire contents of which are incorporated herein by reference.

### TECHNICAL FIELD

The present invention relates to a surveillance camera.

### BACKGROUND ART

Patent Document 1 discloses a surveillance camera in which heat generated by an imaging element or a camera power source is retained and circulated inside a camera housing. The surveillance camera includes a convection fan and a discharge fan as means for circulating and circulating the heat generated by the imaging element or the camera power source. The heat is dispersed in a front surface direction of a lens by a fan. Further, air suctioned into the camera is discharged by the discharge fan fixed to a side opposite to the air intake to the camera. The air dispersed in the front surface direction of the lens hits a front glass and circulates along an inner surface of the front glass. The air discharged from the convection fan and the air circulated along the inner surface of the front glass are circulated and returned to an area rearward of the convection fan, and circulated again by the convection fan.

### CITATION LIST

### Patent Literature

Patent Literature 1: JP 2008-28597 A

### SUMMARY OF INVENTION

However, for a compact camera that does not require a large installation space, it is difficult to provide a fan and a fan duct inside the camera due to its small size.

The present disclosure has been made in view of the circumstances of the related art described above, and an object thereof is to improve heat exhaust efficiency in a surveillance camera having a small size.

The present disclosure provides a surveillance camera including a housing accommodating at least one heat generation source in an accommodating space; a first housing formed using a metal material, partially constituting the housing, and covering a back surface side of the accommodating space; an intermediate member formed using the metal material and fitted into the first housing to form the accommodating space; a second housing combined with the first housing to constitute the housing; at least one substrate disposed in the accommodating space and on which the at least one heat generation source is mounted; and a first heat transfer unit contacting with the first housing and the at least one heat generation source, and transferring heat of the at least one heat generation source to the first housing.

According to the present disclosure, it is possible to improve heat exhaust efficiency in a surveillance camera having a small size.

### BRIEF DESCRIPTION OF DRAWINGS

FIG. 1 is a front view of a surveillance camera according to a first embodiment;

FIG. 2 is a side view of the surveillance camera;

FIG. 3 is a back perspective view of the surveillance camera;

FIG. 4 is an exploded perspective view of the surveillance camera illustrated in FIG. 1;

FIG. 5 is an exploded perspective view of a lens module;

FIG. 6 is an exploded perspective view of a substrate assembly;

FIG. 7 is a cross-sectional view taken along line A-A of FIG. 1;

FIG. 8 is a cross-sectional view taken along line B-B of FIG. 1;

FIG. 9 is an exploded perspective view of a surveillance camera according to a modification of the first embodiment;

FIG. 10 is an exploded perspective view of the surveillance camera according to the modification of the first embodiment; and

FIG. 11 is an exploded perspective view of a substrate assembly of the surveillance camera according to the modification of the first embodiment.

### DESCRIPTION OF EMBODIMENTS

Hereinafter, embodiments that specifically disclose a surveillance camera according to the present disclosure will be described in detail with reference to the accompanying drawings as appropriate. However, more detailed description than necessary may be omitted. For example, detailed description of already well-known matters and duplicate description for substantially the same configuration may be omitted. This is to avoid unnecessary redundancy in the following description and to facilitate the understanding of those skilled in the art. Note that the accompanying drawings and the following descriptions are provided to allow those skilled in the art to fully understand the present disclosure and do not intend to limit the subject matter described in the claims.

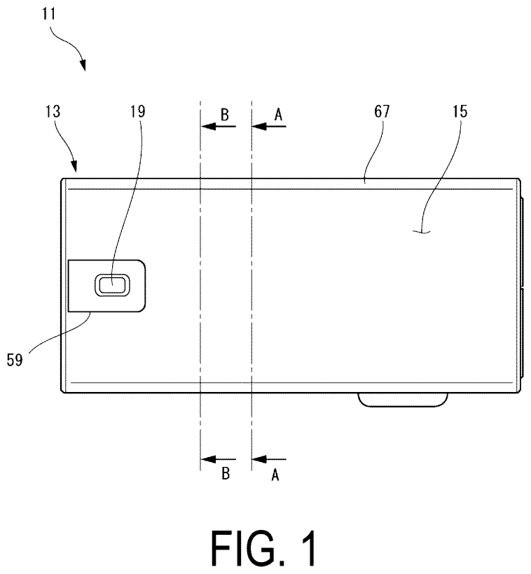

FIG. 1 is a front view of a surveillance camera 11 according to a first embodiment.

The surveillance camera 11 according to the first embodiment includes a housing 13. The housing 13 is formed in a substantially rectangular shape and includes a front surface 15 and a back surface 17 as a pair parallel to each other in a longitudinal direction. The housing 13 includes a lens 19 on the front surface 15.

Note that the front surface 15 herein is a surface on a side where the surveillance camera 11 captures a video. Further, the back surface 17 is a surface on a side opposite to the side where the surveillance camera 11 captures a video. Note that the surveillance camera 11 illustrated in FIG. 1 is a wired model that executes transmission of a captured video using a communication cable 91. The communication cable 91 is connected to the back surface 17 side.

The lens 19 is disposed with a lens center axis being offset from a point of intersection between the pair of diagonals of the rectangular shape of the front surface 15. The lens 19 is disposed on the front surface 15, close to a center portion of one short side. The lens center axis of the lens 19 is perpendicular to the front surface 15. The lens 19 is disposed inside a black frame 59.

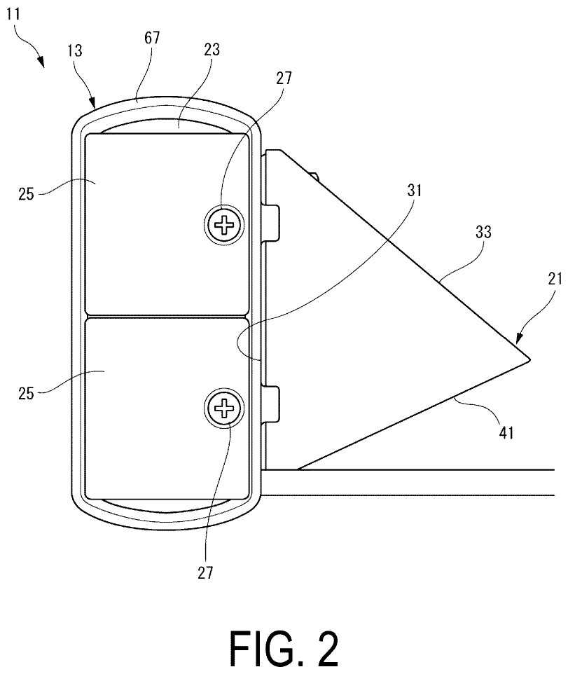

FIG. 2 is a side view of the surveillance camera 11.

An attachment seat 21 formed using a metal material (aluminum alloy containing aluminum, for example) as a component for connection is fixed to the back surface 17 of the housing 13. The surveillance camera 11 includes a pair of side surfaces 23 parallel to each other and interposed between the front surface 15 and the back surface 17. Two side covers 25 arranged vertically are attached to at least one side surface 23.

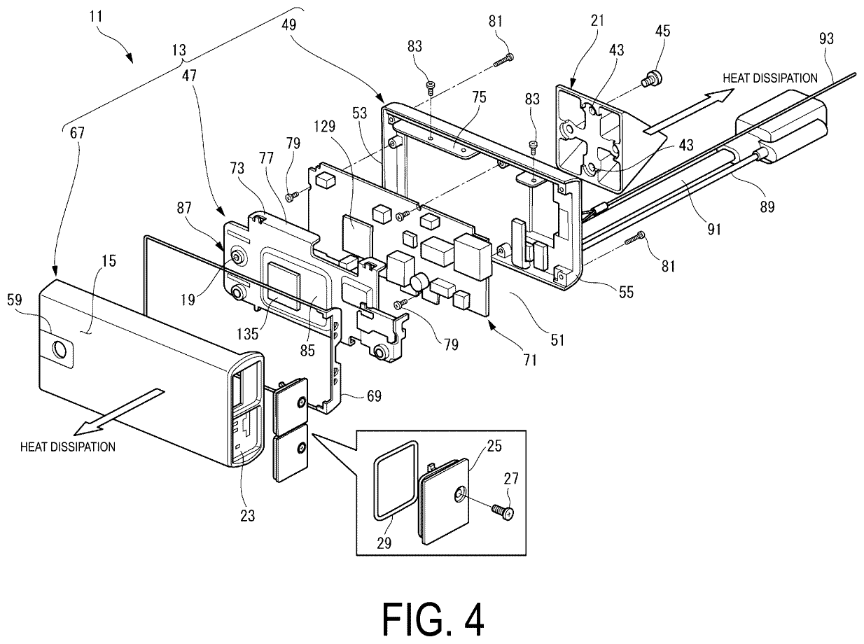

The side covers 25 openably and closably cover an operation portion (not illustrated) provided on the side surface 23 and configured to receive a setting operation of the surveillance camera 11, a connection portion to which an external storage medium or the like can be attached and detached, and the like. The side cover 25 is fixed to the side surface 23 using a fixing screw 27. The side cover 25 includes a rectangular frame rubber seal 29 (refer to FIG. 4) between the side surface 23 of the housing 13 and the side cover 25. The rectangular frame rubber seal 29 achieves a watertight state between the housing 13 and the side surface 23.

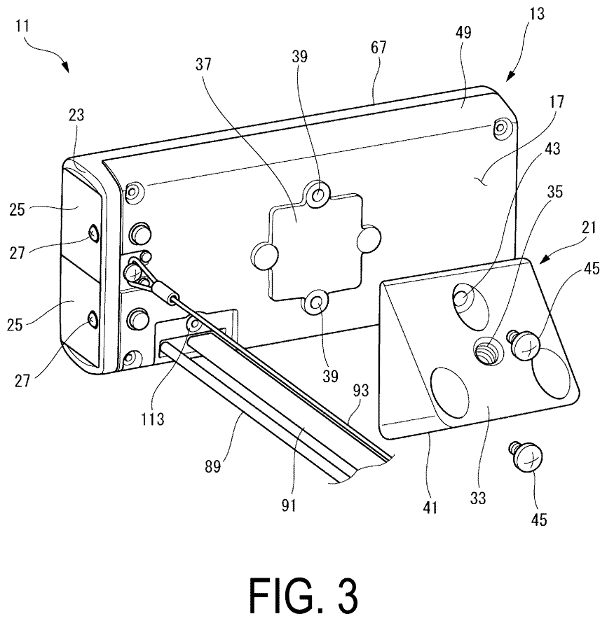

FIG. 3 is a back perspective view of the surveillance camera 11.

The attachment seat 21 is formed in, for example, a substantially triangular prism shape. In the attachment seat 21, two through-holes 43 are respectively formed in a pair of parallel surfaces each having triangular shapes. Of the attachment seat 21, a first surface 31 (refer to FIG. 2) formed in a substantially rectangular shape is fixed to the back surface 17 of the housing 13. The attachment seat 21 is provided with a support shaft screw hole 35 in a second surface 33 formed in a substantially rectangular shape.

A support shaft (not illustrated) that can be operated in a pitch direction and a roll direction can be screwed into the support shaft screw hole 35. The support shaft is supported by a pole or the like via a ball joint (not illustrated), for example. The pole is fixed at an attachment position of the surveillance camera 11. Thus, the surveillance camera 11 is attached at a desired imaging angle by an administrator of the surveillance camera 11, and can capture a video of a surveillance area corresponding to the angle of view of the surveillance camera 11.

A built-up portion 37 is formed on the back surface 17 of the housing 13. The built-up portion 37 is formed in a substantially rectangular shape and protrudes from the back surface 17. The built-up portion 37 is provided with two bolt fixing holes 39. The through-holes 43 are also formed in the second surface 33 and a third surface 41 of the attachment seat 21 at positions corresponding to the two bolt fixing holes 39, respectively.

The attachment seat 21 is attached to the built-up portion 37 of the back surface 17 by inserting two fixing bolts 45 into the two through-holes 43 and screwing the two fixing bolts 45 into the two bolt fixing holes 39. The built-up portion 37 is formed using a metal material (aluminum alloy containing aluminum, for example).

The housing 13 includes a front housing 67 (refer to FIG. 4) on the front surface 15 side and a back housing 49 on the back surface 17 side. With the front housing 67 and the back housing 49 combined, an accommodating space 51 (refer to FIG. 4) is formed inside the housing 13.

The back housing 49 is formed into a box shape, is made of a metal material, and constitutes part of the housing 13. In the back housing 49, a front opening 53 (refer to FIG. 4) on the front surface 15 side covers a back surface side of the accommodating space 51. An intermediate member 47 is fixed to the back housing 49 by a plurality of substrate fixing screws 79 in a state of being fitted inside the front opening 53, thereby covering a front surface side of the accommodating space 51. The intermediate member 47 is formed using a metal material.

The surveillance camera 11 is installed with the longitudinal direction of the surveillance camera 11 aligned with a direction along an installation surface such as a ceiling or a floor (hereinafter referred to as “lateral direction”), for example. The housing 13 of the surveillance camera 11 has, for example, a width of about 76 mm, a height of about 48 mm, and a depth of about 21 mm. Further, the surveillance camera 11 has a dimension in the lateral direction that is greater than a dimension in a height direction substantially orthogonal to the lateral direction.

FIG. 4 is an exploded perspective view of the surveillance camera 11 illustrated in FIG. 1.

The surveillance camera 11 is configured using the front housing 67, a waterproof rubber seal 69, the intermediate member 47, a substrate assembly 71, the back housing 49, and the attachment seat 21, from the front surface 15 side to the back surface 17 side. Note that each of the intermediate member 47, the back housing 49, and the attachment seat 21 is formed using a metal material (aluminum alloy containing aluminum, for example). Further, the front housing 67 is formed using, for example, a resin.

The intermediate member 47 includes a rear opening 73 that fits inside the front opening 53 of the back housing 49. The intermediate member 47 is fixed to an outer frame plate 75 of the front opening 53 in the back housing 49 by a plurality of frame plate fixing screws 83 in a state in which an inner frame plate 77 of the rear opening 73 is stacked on the outer frame plate 75 on an inner side. The substrate assembly 71 is fixed to the back housing 49 by a plurality of the substrate fixing screws 79. The back housing 49 is fixed to the front housing 67 by a plurality of housing fixing screws 81.

In the intermediate member 47, a lens module 87 including the lens 19 is fixed to an end of a front wall front surface 85 of the intermediate member 47. Each of the two side covers 25 is openably and closably attached to the side surface 23 of the front housing 67. Each of the two side covers 25 attached to the side surface 23 is fixed to the side surface 23 by the side cover fixing screw 27. A power cable 89, the communication cable 91, a wire cable 93, and the like are connected at the back surface 17 of the back housing 49. The communication cable 91 transmits a captured video captured by the surveillance camera 11 to an external terminal. The power cable 89 supplies power to the surveillance camera 11.

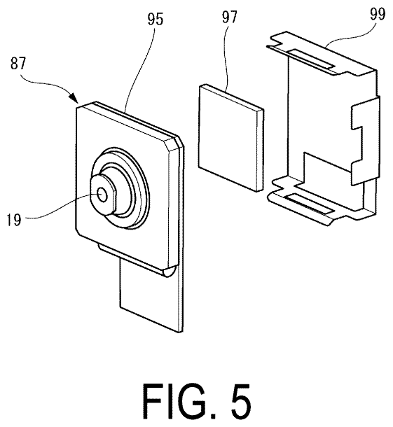

FIG. 5 is an exploded perspective view of the lens module 87.

The lens 19 is attached to a module main body 95 having a plate shape and constituting the lens module 87. The lens 19 is attached with a center thereof being oriented in a vertical direction. The module main body 95 is fixed to an attachment bracket 99 made of a metal with a heat transfer sheet (module heat transfer sheet 97) interposed between the module main body 95 and the attachment bracket 99. The lens module 87 is configured such that the attachment bracket 99 is fixed to the front wall front surface 85 of the intermediate member 47, causing heat generated by driving the surveillance camera 11 to flow to the intermediate member 47 (that is, to be exhausted).

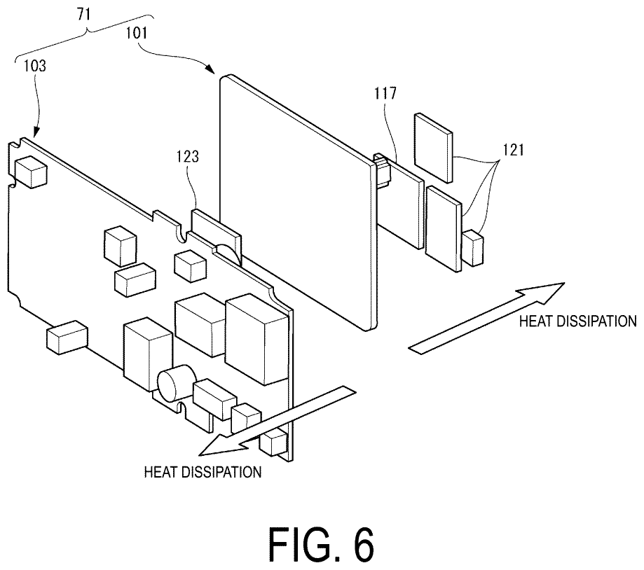

FIG. 6 is an exploded perspective view of the substrate assembly 71.

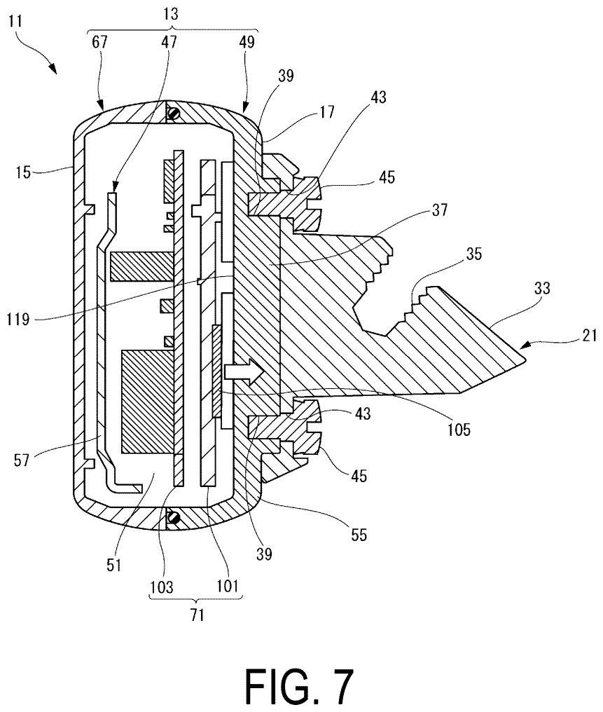

In the substrate assembly 71, a first substrate 101 and a second substrate 103 that are substantially parallel to the back surface 17 are incorporated facing each other. A heat generation source 105 (refer to FIG. 7) that generates the largest amount of heat in the surveillance camera 11 is mounted on the first substrate 101.

The heat generation source 105 is, for example, a system on chip (SOC), a double data rate (DDR), an integrated circuit (IC), or a heat generation component. One or more heat generation sources 105 are mounted on each of the first substrate 101 and the second substrate 103.

A component mounting surface of the first substrate 101 is on the back surface 17 side. A component mounting surface of the second substrate 103 is on the front surface 15 side. That is, surfaces of the first substrate 101 and the second substrate 103 that are opposite to the component mounting surfaces face each other. Note that the component mounting surfaces of the first substrate 101 and the second substrate 103 (that is, mounting surfaces on which the heat generation sources 105 are mounted) need not be limited to the example described above.

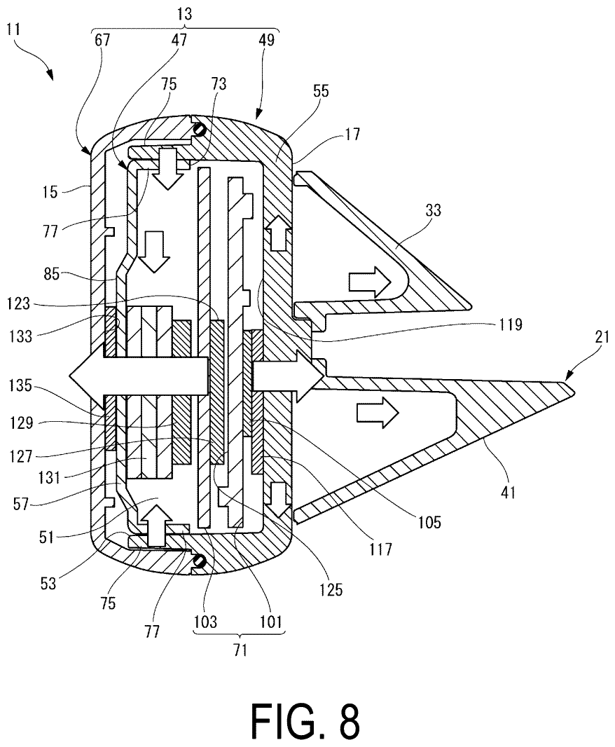

Next, a heat dissipation method for the surveillance camera 11 according to the first embodiment will be described with reference to FIG. 7 and FIG. 8. FIG. 7 is a cross-sectional view taken along line A-A of FIG. 1. FIG. 8 is a cross-sectional view taken along line B-B of FIG. 1.

Each of the intermediate member 47, the back housing 49, and the attachment seat 21 is configured of, for example, an aluminum alloy. Accordingly, the surveillance camera 11 can have improved heat transfer efficiency of the housing 13 and dissipate the heat present in the accommodating space 51 into outside air from each of the front housing 67, the back housing 49, and the attachment seat 21.

The heat transfer sheet is formed by, for example, mixing a filler having insulating properties, such as ceramic, with silicone rubber. The heat transfer sheet has high thermal conductivity. The heat transfer sheet can compensate for unevenness at a contact surface by utilizing elasticity of the silicon rubber, which is the material of the heat transfer sheet, increase adhesion between the heat generation source 105 and the housing 13, and improve the heat transfer efficiency from the heat generation source 105 to the housing 13.

A heat transfer sheet (first heat transfer sheet 117) is disposed between the first substrate 101 and the back housing 49. The first substrate 101 includes the heat generation source 105 and is accommodated in the accommodating space 51, while being substantially parallel to the back surface 17.

The first heat transfer sheet 117 is disposed between the heat generation source 105 on the first substrate 101 and a rear wall inner surface 119 of the back housing 49. The first heat transfer sheet 117 transfers heat generated from the heat generation source 105 to the rear wall inner surface 119 of the back housing 49.

Further, each of a plurality of heat transfer sheets 121 is disposed interposed between the first substrate 101 and the back housing 49 (refer to FIG. 6). Each of the plurality of heat transfer sheets 121 transfers heat generated from the heat generation source 105 to a rear wall 55 of the back housing 49.

As a result, the heat transferred to the rear wall inner surface 119 is transferred to the entire back housing 49 and exhausted to outside air from the back surface 17, which is in contact with outside air. A heat transfer path in this case extends through the rear wall 55 of the back housing 49 in a thickness direction, and thus there is no heat insulator, space, or the like that would act as heat transfer resistance, enabling more efficient heat transfer (that is, heat exhaust).

The back housing 49 releases some of the transferred heat from a front surface of the back housing 49 to outside air, and further transfers the remaining unreleased heat to the built-up portion 37, the attachment seat 21, and the intermediate member 47, each formed using a metal member such as an aluminum alloy.

Note that, in the surveillance camera 11, the back housing 49 in contact with the heat generation source 105 with the first heat transfer sheet 117 interposed therebetween is formed thicker than the intermediate member 47 formed using the same metal material. Thus, a heat capacity of the back housing 49 in contact with the heat generation source 105 is greater than a heat capacity of the intermediate member 47. Further, since the back surface 17 is in contact with outside air and heat can be transferred to the attachment seat 21 formed using the same metal material, the heat dissipation amount of the back housing 49 is greater than the heat dissipation amount of the intermediate member 47.

The attachment seat 21 releases the heat transferred from the back housing 49 via the built-up portion 37 to outside air from a front surface of the attachment seat 21, which is in contact with outside air. The intermediate member 47 further transfers the heat transferred from the back housing 49 to a fourth heat transfer sheet 135 in contact with the intermediate member 47. The fourth heat transfer sheet 135 further transfers the heat transferred from the intermediate member 47 to the front housing 67. The front housing 67 releases the transferred heat to outside air from a front surface of the front housing 67, which is in contact with outside air.

A second heat transfer sheet 123 is disposed between the first substrate 101 and the second substrate 103. The second heat transfer sheet 123 transfers heat generated from the first substrate 101 to the second substrate 103.

In the surveillance camera 11, the second substrate 103 is disposed on a first substrate front surface 125 of the first substrate 101 disposed on the side opposite to the heat generation source 105, while being substantially parallel to the first substrate 101 with the second heat transfer sheet 123 interposed therebetween. A second substrate front surface 127 is in contact with the second heat transfer sheet 123 of the second substrate 103. A third heat transfer sheet 129 is disposed facing a surface of the second substrate 103 on the side opposite to the second substrate front surface 127.

The second substrate 103 transfers the heat transferred from the second heat transfer sheet 123 to the third heat transfer sheet 129 and dissipates the heat into the accommodating space 51.

The third heat transfer sheet 129 is in contact with a front wall 57 of the intermediate member 47 with a laminated copper plate 131 interposed therebetween. The third heat transfer sheet 129 transfers the heat transferred from the second substrate 103 to the laminated copper plate 131. Note that, in the laminated copper plate 131, the number of copper plates laminated may vary on the basis of a distance between the third heat transfer sheet 129 and the intermediate member 47, or the laminated copper plate may be configured using one copper plate.

The housing 13 includes the front housing 67 that has a box shape and is formed using a resin material, and that covers the intermediate member 47 from the outside and is fitted onto the back housing 49. The fourth heat transfer sheet 135 is disposed between the intermediate member 47 and the front housing 67. Further, the fourth heat transfer sheet 135 is disposed in contact with the front wall front surface 85, positioned on the side opposite to the laminated copper plate 131, and with a front housing back surface 133.

The laminated copper plate 131 transfers the heat transferred from the second substrate 103 to the intermediate member 47. The intermediate member 47 transfers the heat transferred from the laminated copper plate 131 to the fourth heat transfer sheet 135. The fourth heat transfer sheet 135 transfers the heat transferred from the laminated copper plate 131 to the front housing 67. The front housing 67 releases the transferred heat to outside air from the front surface of the front housing 67, which is exposed to outside air.

As described above, the surveillance camera 11 according to the first embodiment can dissipate the heat generated from the substrate assembly 71 (that is, the heat generation source 105) to outside of the housing 13.

### Modification of First Embodiment

The surveillance camera 11 according to the first embodiment is an example of a heat dissipation structure of the surveillance camera 11 to which a wired cable such as the communication cable 91 is connectable. A surveillance camera 137 according to a modification of the first embodiment is an example of a heat dissipation structure of the surveillance camera 137 to which a wired cable such as the communication cable 91 is not connectable, and an external shape of the housing 13 and a volume of the accommodating space 51 of the housing 13 are made smaller than those of the surveillance camera 11 according to the first embodiment by omitting the space required for connection of the wired cable.

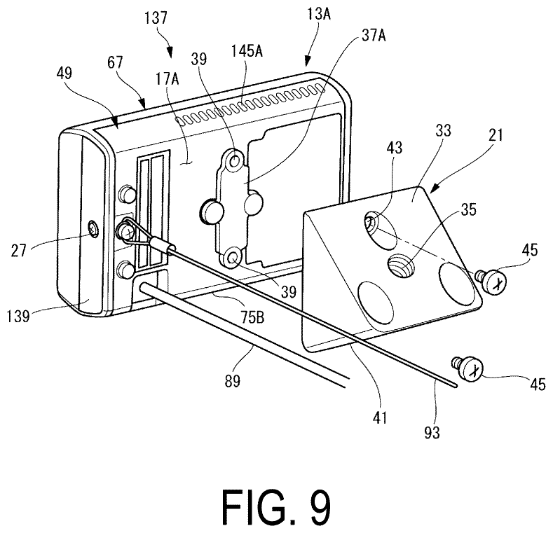

FIG. 9 is an exploded perspective view of the surveillance camera 137 according to the modification of the first embodiment. Note that, in the following description, the same components as those in the first embodiment are denoted by the same reference signs, and description thereof will be omitted.

The surveillance camera 137 according to the modification of the first embodiment is a so-called wireless model that does not require a wired cable, such as the communication cable 91. Further, the outer shape of the housing 13 and the volume of the accommodating space 51 of the housing 13 are further reduced than those of the surveillance camera 11 of the first embodiment. Specifically, in the surveillance camera 137, a length of the housing in the longitudinal direction is shorter than that in the surveillance camera 11 of the first embodiment. Accordingly, an accommodating space 51A of the surveillance camera 137 is smaller than the accommodating space 51 of the surveillance camera 11. Note that the attachment seat 21 is the same as the attachment seat 21 of the surveillance camera 11.

The surveillance camera 137 includes one side cover 139 on a side surface 23A interposed between the front surface 15 and the back surface 17. The side cover 139 is formed in a substantially rectangular shape including long sides in a direction substantially orthogonal to a longitudinal direction of a housing 13A. The side cover 139 is attachable to and detachable from the side surface 23A by the side cover fixing screw 27, and covers an operation portion (not illustrated) and a connection portion (not illustrated) in an openable and closable manner. The power cable 89 and the wire cable 93 are connected to a back surface 17A.

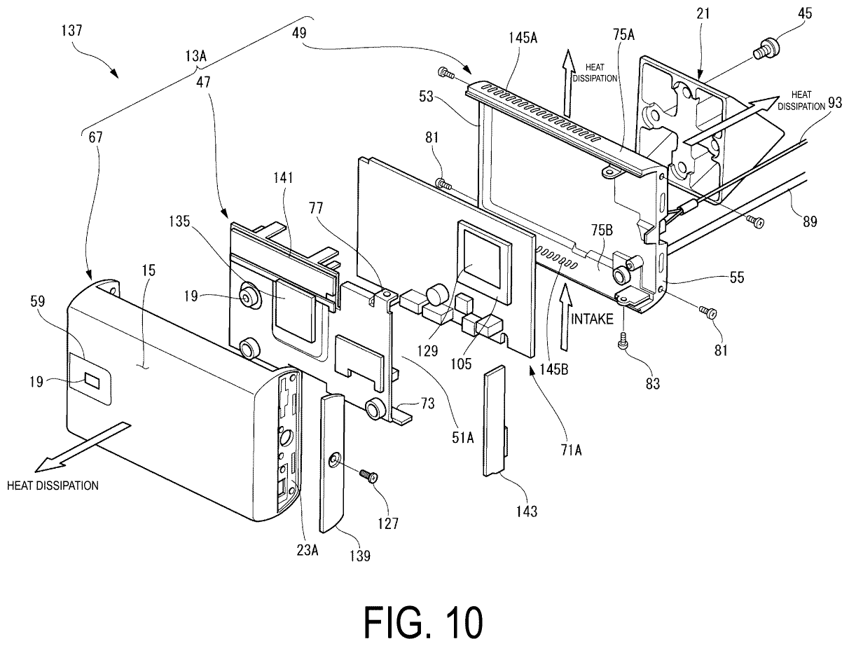

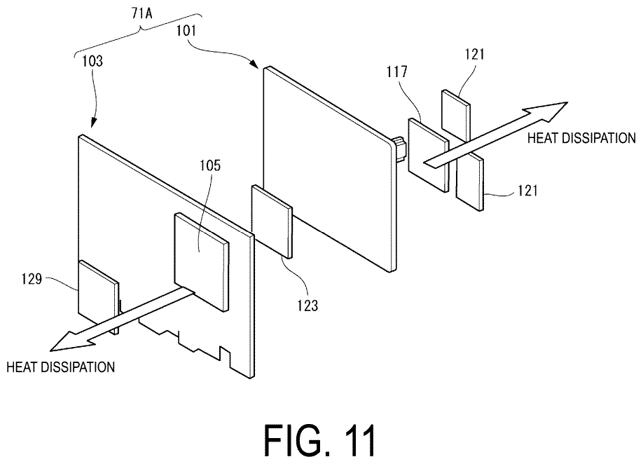

FIG. 10 is an exploded perspective view of the surveillance camera 137 according to the modification of the first embodiment. FIG. 11 is an exploded perspective view of a substrate assembly 71A in the surveillance camera 137 according to the modification of the first embodiment.

On the substrate assembly 71A of the surveillance camera 137 according to the modification of the first embodiment, an IC for wireless communication is additionally mounted, increasing the amount of heat generated from the substrate assembly 71A. Note that the surveillance camera 137 according to the modification of the first embodiment adopts a configuration that does not include the waterproof rubber seal 69.

In the surveillance camera 137, a first antenna 141 for wireless communication, which is long in the longitudinal direction of the housing, and a second antenna 143, which is long in a direction orthogonal to the first antenna 141, are attached to the intermediate member 47.

In the surveillance camera 137, vent holes 145A, 145B that allow for communication between the accommodating space 51A and the outside (outside air) are formed in each of a pair of outer frame plates 75A, 75B parallel to each other and extending in the longitudinal direction of the back housing 49. That is, the vent holes 145A are provided in the outer frame plate 75A of the back housing 49. The vent holes 145B are provided in the outer frame plate 75B of the back housing 49.

The vent holes 145A are provided in the outer frame plate 75A and discharge air having a high temperature in the accommodating space 51A to the outside (outside air). Air in an amount equivalent to that discharged to the outside (outside air) flows into the accommodating space 51A from the vent holes 145B provided in the outer frame plate 75B. Accordingly, the surveillance camera 137 can discharge the air heated in the accommodating space 51A (exhaust the heat) through each of the vent holes 145A, 145B.

As described above, the surveillance cameras 11, 137 according to the first embodiment and the modification of the first embodiment include the housing 13, 13A accommodating at least one heat generation source 105 in the accommodating space 51, 51A; the back housing 49 (example of first housing) formed using a metal material (aluminum alloy including aluminum, for example), partially constituting the housing 13, 13A, and covering the back surface side of the accommodating space 51, 51A; the intermediate member 47 formed using the metal material (aluminum alloy including aluminum, for example) and fitted into the back housing 49 to form the accommodating space 51, 51A; the front housing 67 (example of second housing) combined with the back housing 49 to constitute the housing 13, 13A; at least one of the first substrate 101 or the second substrate 103 (example of substrate) on which the heat generation source 105 is mounted, the at least one of the first substrate 101 or the second substrate 103 being disposed in the accommodating space 51, 51A; and the first heat transfer sheet 117 (example of first heat transfer unit) in contact with the back housing 49 and the heat generation source 105, allowing the heat of the heat generation source 105 to be transferred to the back housing 49.

Accordingly, in the surveillance cameras 11, 137 according to the first embodiment and the modification of the first embodiment, the heat generated from the heat generation source 105 is transferred, by the first heat transfer sheet 117, to the back housing 49 formed using a metal material and having high thermal conductivity. The surveillance cameras 11, 137 dissipate the heat, which is generated from the heat generation source 105 and transferred, from the front surface of the back housing 49 in contact with outside air, making it possible to improve the heat exhaust efficiency.

As described above, in the surveillance cameras 11, 137 according to the first embodiment and the modification of the first embodiment, the back housing 49 transfers the heat of the heat generation source to the intermediate member 47 from the outer frame plate 75 (example of fitting portion) at which the inner frame plate 77 of the intermediate member 47 is fitted into the back housing 49. Thus, the surveillance cameras 11, 137 according to the first embodiment and the modification of the first embodiment disperse the amount of heat transferred to the back housing 49 by transferring the heat of the heat generation source 105 not only to the back housing 49 but also to the intermediate member 47 to exhaust the heat. Accordingly, the surveillance cameras 11, 137 can have further improved heat exhaust efficiency.

Further, as described above, the surveillance cameras 11, 137 according to the first embodiment and the modification of the first embodiment further include the attachment seat 21 formed using a metal material (aluminum alloy including aluminum, for example) and fixed to the back housing 49, the attachment seat 21 being configured to fix and install the surveillance cameras 11, 137 at a predetermined installation location. Accordingly, in the surveillance cameras 11, 137 according to the first embodiment and the modification of the first embodiment, the heat of the heat generation source 105 transferred to the back housing 49 can be further transferred to the attachment seat 21. That is, in the surveillance cameras 11, 137, the amount of heat transferred to the back housing 49 can be dispersed by transferring the heat of the heat generation source to the intermediate member 47 and the attachment seat 21. Further, the surveillance cameras 11, 137 release the heat transferred from the back housing 49 from the front surface of the attachment seat 21 formed using a metal material, the front surface being in contact with outside air, making it possible to further improve the heat exhaust efficiency.

Further, as described above, the surveillance cameras 11, 137 according to the first embodiment and the modification of the first embodiment further include the second heat transfer sheet 123 (example of second heat transfer unit) provided on the side opposite to the first heat transfer sheet 117, allowing the heat of the heat generation source 105 to be transferred to the intermediate member 47. Accordingly, in the surveillance cameras 11, 137 according to the first embodiment and the modification of the first embodiment, the heat of the heat generation source 105 can be transferred not only to the back housing 49 but also to the intermediate member 47 and the attachment seat 21, making it possible to dissipate the heat while dispersing the amount of heat transferred to the back housing 49. That is, in the surveillance cameras 11, 137, the heat of the heat generation source 105 is more widely dispersed, making it possible to further improve the heat exhaust efficiency.

Further, as described above, the intermediate member 47 of the surveillance cameras 11, 137 according to the first embodiment and the modification of the first embodiment includes at least one laminated copper plate 131 (example of metal plate) disposed, facing the second heat transfer sheet 123, on a surface on the accommodating space 51, 51A side. Accordingly, in the surveillance cameras 11, 137 according to the first embodiment and the modification of the first embodiment, the heat transferred to the second heat transfer sheet 123 or the heat dissipated into the accommodating space 51, 51A can be transferred to the intermediate member 47 by the laminated copper plate 131. Accordingly, in the surveillance cameras 11, 137, the heat inside the housing 13 and in the accommodating space 51, 51A accommodating the heat generation source 105 can be transferred to the intermediate member 47.

Further, as described above, the surveillance cameras 11, 137 according to the first embodiment and the modification of the first embodiment further include the fourth heat transfer sheet 135 (example of third heat transfer unit) provided between the intermediate member 47 and the front housing 67, allowing the heat of the heat generation source 105 to be transferred from the intermediate member 47 to the front housing 67. The housing 13, 13A accommodates the intermediate member 47 and the accommodating space 51, 51A. Accordingly, in the surveillance cameras 11, 137 according to the first embodiment and the modification of the first embodiment, the heat transferred from the intermediate member 47 can be transferred to the front housing 67 in contact with outside air, making it possible to more widely disperse the heat of the heat generation source 105. Further, the surveillance cameras 11, 137 dissipate the heat from the front surface of the front housing 67 to outside air, making it possible to further improve the heat exhaust efficiency.

Further, as described above, the back housing 49 of the surveillance cameras 11, 137 according to the first embodiment and the modification of the first embodiment has a thermal conductivity higher than a thermal conductivity of the front housing 67 and is formed thicker than a thickness of the front housing 67. Accordingly, in the surveillance cameras 11, 137 according to the first embodiment and the modification of the first embodiment, the heat capacity of the back housing 49 to which the heat of the heat generation source 105 is transferred via the first heat transfer sheet 117 is increased, and more heat is dissipated from the back housing 49 close to the heat generation source 105, making it possible to further improve the heat exhaust efficiency.

Further, as described above, in the back housing 49 of the surveillance camera 137 according to the modification of the first embodiment, the vent holes 145A, 145B that allow for communication between the accommodating space 51A and the outside are formed in each of the pair of outer frame plates 75A, 75B (example of surface) extending in the longitudinal direction. Accordingly, in the surveillance camera 137 according to the modification of the first embodiment, the heat dissipated from the heat generation source 105 into the accommodating space 51A can be dissipated through the vent holes 145A, and outside air can be drawn through the vent holes 145B. Accordingly, the surveillance camera 137 according to the modification of the first embodiment can have further improved heat exhaust efficiency, even when including the housing 13A in which the accommodating space 51A is small. Further, in the surveillance camera 137, each of the vent holes 145A, 145B is provided in a direction substantially orthogonal to the lateral direction, which is the installation direction of the surveillance camera 137. This makes it possible to more efficiently replace the air (that is, exhaust the heat) in the accommodating space 51A on the basis of a temperature difference between a temperature of the air in the accommodating space 51A and a temperature outside of the housing 13A (that is, of outside air) and improve the heat exhaust efficiency.

Although various embodiments have been described above with reference to the drawings, it is needless to say that the present disclosure is not limited to such examples. It will be apparent to those skilled in the art that various alterations, modifications, substitutions, additions, deletions, and equivalents can be conceived within the scope set forth in the claims, and it should be understood that such changes also belong to the technical scope of the present disclosure. Further, each component in the various embodiments described above may be combined as desired in the range without deviating from the spirit of the invention.

Note that the present application is based on a Japanese patent application (JP 2022-017265 A) filed on Feb. 7, 2022, the contents of which are incorporated herein by reference.

### INDUSTRIAL APPLICABILITY

The present disclosure is useful, for a surveillance camera having a small size, as a surveillance camera that can have improved heat exhaust efficiency.

What is claimed is:

1. A surveillance camera comprising:
a housing accommodating at least one heat generation source in an accommodating space;
a first housing formed using a metal material, partially constituting the housing, and covering a back surface side of the accommodating space;
an intermediate member formed using the metal material and fitted into the first housing to form the accommodating space;
a second housing combined with the first housing to constitute the housing;
at least one substrate disposed in the accommodating space and on which the at least one heat generation source is mounted; and
a first heat transfer unit contacting with the first housing and the at least one heat generation source, and transferring heat of the at least one heat generation source to the first housing.

2. The surveillance camera according to claim 1, wherein
the first housing includes a fitting portion that is fitted to the intermediate member, and,
the first housing transfers the heat of the at least one heat generation source to the intermediate member from the fitting portion.

3. The surveillance camera according to claim 1, further comprising:
an attachment seat formed using the metal material and fixed to the first housing to fix and install the surveillance camera at a predetermined installation location.

4. The surveillance camera according to claim 1, further comprising:
a second heat transfer unit provided on a side opposite to the first heat transfer unit and transferring the heat of the at least one heat generation source to the intermediate member.

5. The surveillance camera according to claim 4, wherein
the intermediate member includes at least one metal plate disposed on a surface on the accommodating space side so as to face the second heat transfer unit.

6. The surveillance camera according to claim 1, further comprising:
a third heat transfer unit provided between the intermediate member and the second housing, and transferring the heat of the at least one heat generation source from the intermediate member to the second housing, wherein
the housing accommodates the intermediate member and the accommodating space.

7. The surveillance camera according to claim 6, wherein
the first housing has a thermal conductivity higher than a thermal conductivity of the second housing, and is formed thicker than a thickness of the second housing.

8. The surveillance camera according to claim 1, wherein
the first housing includes a vent hole on each of a pair of surfaces extending in a longitudinal direction of the housing so as to communicates the accommodating space with the outside.
